(19) United States
(12) Patent Application Publication
(10) Pub. No.: US 2026/0094915 A1
(43) Pub. Date: Apr. 2, 2026

(54) ELECTRIC POWER STORAGE APPARATUS

(71) Applicant: TOYOTA JIDOSHA KABUSHIKI KAISHA, Toyota-shi (JP)

(72) Inventor: Yuta TAKAHASHI, Seto-shi (JP)

(73) Assignee: TOYOTA JIDOSHA KABUSHIKI KAISHA, Toyota-shi (JP)

(21) Appl. No.: 19/247,205

(22) Filed: Jun. 24, 2025

(30) Foreign Application Priority Data
Sep. 27, 2024 (JP) 2024-168059

(51) Int. Cl. H01M 50/258; H01M 50/291

(52) U.S. Cl. CPC H01M 50/258; H01M 50/291

(57) ABSTRACT

An electric power storage apparatus includes an electric power storage module, a lower case configured to house the electric power storage module, and a positioning member configured to abut both a side surface of the electric power storage module and an inner wall of the lower case and limit the relative movement of the electric power storage module in the lower case. The positioning member is provided in a gap in which the side surface and the inner wall face each other. The positioning member includes a material having thermal conductivity. The material is deformable according to the gap.

### CROSS-REFERENCE TO RELATED APPLICATION

This application claims priority to Japanese Patent Application No. 2024-168059 filed on Sep. 27, 2024. The disclosure of the above-identified application, including the specification, drawings, and claims, is incorporated by reference herein in its entirety.

### BACKGROUND

### 1. Technical Field

The present disclosure relates to an electric power storage apparatus.

### 2. Description of Related Art

For example, Japanese Patent No. 4858660 (JP 4858660 B) describes an assembly structure for a secondary battery. The assembly structure includes positioning pins.

### SUMMARY

In a case where the distance between parts is short or parts easily move before being fastened, parts are sometimes assembled by using positioning pins or positioning structures are sometimes set to avoid contact between the fastened parts or avoid abnormal sound caused by the contact. However, the use of positioning pins in a production step sometimes increases the production cost of full automation because additional steps are necessary, such as a step of attaching the positioning pins, a step of detaching the positioning pins, and a step of reusing the positioning pins. Setting positioning structures for the purpose of positioning alone sometimes increases the production cost.

The present disclosure has been devised to solve the problem described above. An object of the present disclosure is to provide an electric power storage apparatus that prevents the positional accuracy of a part from worsening while the production cost is prevented from increasing.

An electric power storage apparatus according to an aspect of the present disclosure includes an electric power storage module, a housing configured to house the electric power storage module, and a positioning member configured to abut both a side surface of the electric power storage module and an inner wall of the housing and limit the relative movement of the electric power storage module in the housing. The positioning member is provided in a gap in which the side surface and the inner wall face each other. The positioning member includes a material having thermal conductivity. The material is deformable according to the gap.

In such a way, it is possible to position the electric power storage module in the housing without using any positioning pin. Furthermore, it is possible to dissipate the heat of the electric power storage module to the housing through the positioning member. It is therefore possible to impart a function of increasing cooling performance to the positioning member in addition to a positioning function. It is thus possible to prevent the positional accuracy of a part from worsening while preventing the production cost from increasing.

In the present embodiment, in the positioning member, the electric power storage module may be sandwiched in a direction defined in advance and the relative movement may be limited in the direction defined in advance.

In such a way, it is possible to dissipate the heat of the electric power storage module to the housing through the positioning members while limiting the relative movement of the electric power storage module.

Furthermore, in the present embodiment, the side surface of the electric power storage module and a surface of the positioning member in contact with the electric power storage module may be respectively provided with a projection and a recess that are fittable together.

In such a way, it is possible to integrally assemble the electric power storage module and the positioning member into the housing and thus increase the assemblability.

Furthermore, in the present embodiment, the housing may include an upper cover and a lower case. The positioning member may be configured such that the upper end of the positioning member abuts the upper cover.

In such a way, it is possible to dissipate the heat of the electric power storage module to the upper cover of the housing through the positioning member in addition to the inner wall of the lower case.

Furthermore, in the present embodiment, the positioning member may further include a projection that abuts the upper surface of the electric power storage module.

In such a way, it is possible to limit even the upward relative movement of the electric power storage module by the projection of the positioning member. It is therefore possible to prevent abnormal sound or the like from being caused.

According to the present disclosure, it is possible to provide an electric power storage apparatus that prevents the positional accuracy of a part from worsening while preventing the production cost from increasing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an electric power storage apparatus according to the present embodiment;

FIG. 2 is a sectional view for describing an example in which an electric power storage module is positioned;

FIG. 3 is a sectional view of an example of the configuration of the electric power storage apparatus according to the present embodiment;

FIG. 4 is a sectional view of an example of a configuration of an electric power storage apparatus according to a modification example; and

FIG. 5 is a sectional view of another example of a configuration of an electric power storage apparatus according to a modification example.

### DETAILED DESCRIPTION OF EMBODIMENTS

Hereinafter, an embodiment of the present disclosure will be described in detail with reference to the drawings. It is to be noted that the same or corresponding portions in the drawings will be denoted by the same reference numerals and will not be repeatedly described.

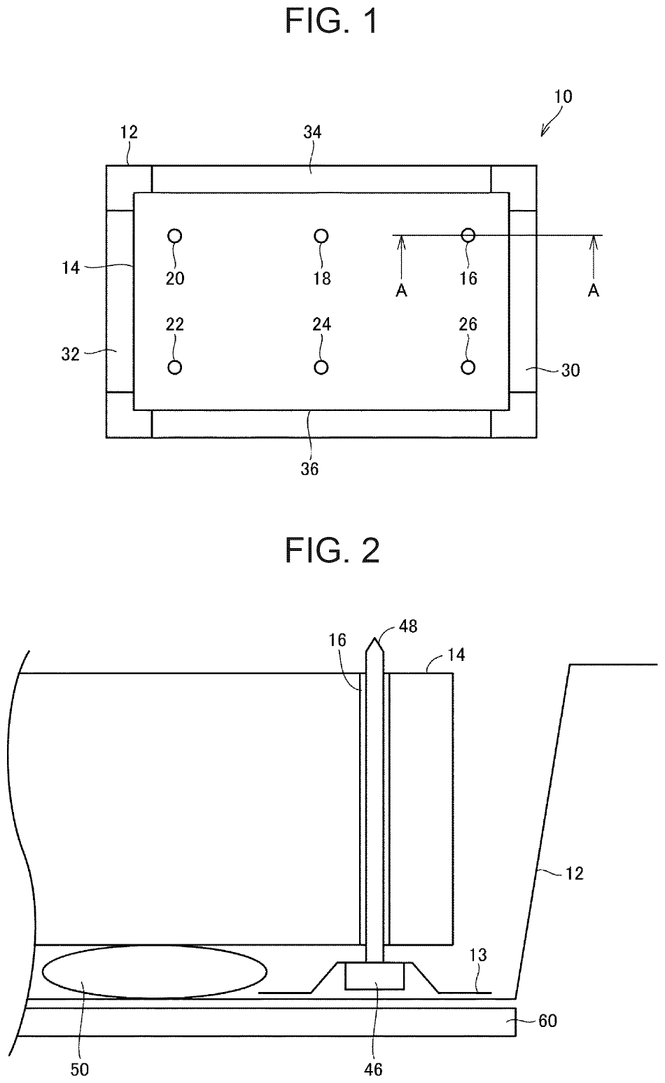

FIG. 1 is a diagram illustrating an example of the configuration of an electric power storage apparatus 10 according to the present embodiment. FIG. 1 is a top view of the electric power storage apparatus 10. The electric power storage apparatus 10 is mounted, for example, on an electrified vehicle, such as a hybrid electric vehicle or a battery electric vehicle, that travels by using an electric motor as a driving source. The electric power storage apparatus 10 has, for example, a rectangular shape and is mounted on a vehicle such that the longitudinal direction of the electric power storage apparatus 10 coincides with the width direction of the vehicle or the front-rear direction of the vehicle. The electric power storage apparatus 10 supplies electric power to an electric motor of the vehicle and is charged upon receiving regenerated electric power from the electric motor.

As illustrated in FIG. 1, the electric power storage apparatus 10 includes an electric power storage module 14, a lower case 12, and positioning members 30, 32, 34, 36.

The electric power storage module 14 includes, for example, a plurality of battery cells arranged in a predetermined direction and connected in series. It is to be noted that the electric power storage module 14 may include, for example, a plurality of battery cell groups connected in series. In each of the battery cell groups, two or more battery cells are connected in parallel.

Each of the battery cells is, for example, a secondary battery, such as a nickel hydride battery or a lithium-ion battery. The battery cell may include a liquid electrolyte or a solid electrolyte. Furthermore, the battery cell may have a polygonal-column shape or a cylindrical shape. Furthermore, the electric power storage apparatus 10 may include one or more chargeable and dischargeable capacitors instead of the battery cells.

The electric power storage module 14 is housed in the lower case 12. A housing includes the lower case 12 and an upper cover (not illustrated) described later. The electric power storage module 14 is attached from an upward opening of the lower case 12 and disposed on a bottom surface of the lower case 12. The electric power storage module 14 has a bolt hole 16 formed thereon in the up-down direction (the foreground-background direction of FIG. 1). The bolt hole 16 may be provided, for example, on an end plate or the like of the electric power storage module 14. A bolt is inserted to the bolt hole 16 and fastened to a nut fixed on the bottom surface of the lower case 12 to fix the electric power storage module 14 to the bottom surface of the lower case 12. The bolt hole 16 is provided at a plurality of positions on the electric power storage module 14. FIG. 1 illustrates, as an example, a case where six bolt holes 16, 18, 20, 22, 24, 26 are formed on the electric power storage module 14 and nuts are fixed at six corresponding positions on the lower case 12. It is sufficient if nuts are fixed at a plurality of positions. Nuts do not have to be fixed at six positions in particular. The upper cover is provided to close the opening of the lower case 12 to which the electric power storage module 14 is fixed.

Here, in a case where the distance between the lower case 12 and the electric power storage module 14 is short, worsened positional accuracy of parts sometimes brings the parts into contact with each other to cause abnormal sound when the vehicle has vibration. Furthermore, in a case where there is provided a heat-conductive material including a silicone-based adhesive or the like between the lower case 12 and the electric power storage module 14, the electric power storage module 14 and the lower case 12 sometimes have a positional deviation before the electric power storage module 14 is fastened to the lower case 12 after the electric power storage module 14 is mounted on the lower case 12. To prevent such worsened positional accuracy or such a positional deviation, it is conceivable to assemble the electric power storage module 14 into the lower case 12 by using, for example, positioning pins.

An example in which the electric power storage module 14 is positioned with respect to the lower case 12 by using positioning pins will be described below. FIG. 2 is a sectional view for describing an example in which the electric power storage module 14 is positioned. FIG. 2 illustrates a diagram corresponding to a section taken along an A-A plane in FIG. 1.

As illustrated in FIG. 2, there is provided a heat-conductive material 50 between the bottom surface of the lower case 12 and the electric power storage module 14. In addition, there is provided a cooling device 60 below the lower case 12. The cooling device 60 is configured, for example, to have a refrigerant flow therein. The cooling device 60 is configured to allow heat to be exchanged with the electric power storage module 14 through the lower case 12 and the heat-conductive material 50.

A nut 46 is fixed to a stand member 13 by welding or the like. The stand member 13 is fixed to the bottom surface of the lower case 12 by welding or the like. A positioning pin 48 is attached to the nut 46. The shape of the stand member 13 is not limited to the shape illustrated in FIG. 2 in particular as long as the shape of the stand member 13 allows the nut 46 to be fastened with a bolt inserted from above when the stand member 13 is fixed to the bottom surface of the lower case 12. The nut 46 may be directly fixed to the lower case 12 by welding or the like.

It is to be noted that the positioning pins 48 may be attached to nuts at the positions corresponding to the respective bolt holes 16, 18, 20, 22, 24, 26. The positioning pins 48 may be attached to nuts at at least two positions. Thereafter, the heat-conductive material 50 is provided on the bottom surface of the lower case 12. The electric power storage module 14 is then attached to the lower case 12 such that the positioning pin 48 is inserted to the bolt hole 16 on the electric power storage module 14. Thereafter, the positioning pin 48 is detached and bolts are inserted to the bolt holes 16, 18, 20, 22, 24, 26. The bolt is fastened to the nut 46 to fix the electric power storage module 14 to the lower case 12.

However, the use of the positioning pin 48 in a step of producing the electric power storage apparatus 10 sometimes increases the production cost of full automation because steps are necessary, such as a step of attaching the positioning pin 48, a step of detaching the positioning pin 48, and a step of reusing the positioning pin 48. In addition, it is also conceivable to set positioning structures on the lower case 12 and the electric power storage module 14 instead of the positioning pins 48. However, setting the positioning structures for the purpose of positioning alone sometimes increases the production cost.

Accordingly, the present embodiment assumes that positioning members are included that are each provided in a gap in which a side surface of the electric power storage module 14 and an inner wall of the lower case 12 included in the housing face each other, abut both the side surface of the electric power storage module 14 and the inner wall of the lower case 12, and limit the relative movement of the electric power storage module 14 in the housing, and the positioning members each include a material having thermal conductivity which is deformable according to the gap between the side surface of the electric power storage module 14 and the inner wall of the housing.

In such a way, it is possible to position the electric power storage module 14 in the housing without using any positioning pins. Furthermore, it is possible to dissipate heat of the electric power storage module 14 to the housing through the positioning members. It is therefore possible to impart a function of increasing cooling performance to the positioning members in addition to a positioning function. It is thus possible to prevent the positional accuracy of a part from worsening while preventing the production cost from increasing.

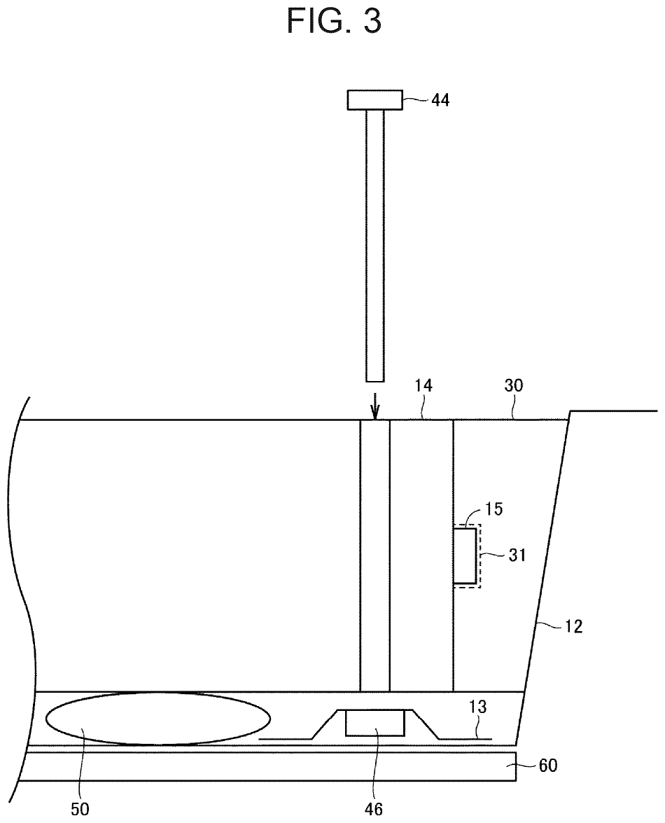

FIG. 3 is a sectional view of an example of the configuration of the electric power storage apparatus 10 according to the present embodiment. FIG. 3 is a sectional view taken along an A-A plane in FIG. 1. As illustrated in FIG. 3, the electric power storage apparatus 10 according to the present embodiment includes the positioning members 30, 32, 34, 36 illustrated in FIG. 1.

As illustrated in FIG. 3, the positioning member 30 is provided in a gap in which a side surface of the electric power storage module 14 and an inner wall of the lower case 12 included in the housing face each other. The positioning member 30 is formed to fill the gap and abuts both the side surface of the electric power storage module 14 and the inner wall of the lower case 12. The positioning member 30 limits the relative movement of the electric power storage module 14 in the lower case 12 by the facing positioning member 32. In the present embodiment, the positioning member 30 corresponds to a “first member” and the positioning member 32 corresponds to a “second member”. The positioning member 30 includes a material a material having thermal conductivity which is deformable according to the gap between the side surface and the inner wall. For example, the material included in the positioning member 30 may be a resin member or an elastic member such as rubber. In addition, as illustrated in FIG. 1, the positioning member 30 is continuously formed along the side surface of the electric power storage module 14 to have length set in advance.

The heat-conductive material 50 is provided between the electric power storage module 14 and the lower case 12. The heat-conductive material 50 is applied, for example, before the electric power storage module 14 is attached to the lower case 12. The heat-conductive material 50 includes, for example, a silicone-based adhesive having high thermal conductivity. The cooling device 60 is provided below the lower case 12. Heat generated in the electric power storage module 14 is exchanged with the cooling device 60 through the lower case 12 and the heat-conductive material 50. The electric power storage module 14 is hereby cooled.

The positioning members 32, 34, 36 are also configured as with the positioning member 30. Therefore, the electric power storage module 14 is provided to be sandwiched between the positioning members 30, 32 in a first direction (the transverse direction of the sheet of FIG. 1) defined in advance. That is, the positioning members 30, 32 limit the relative movement of the electric power storage module 14 with respect to the lower case 12 in the first direction. Similarly, the electric power storage module 14 is provided to be sandwiched between the positioning members 34, 36 in a second direction (the vertical direction of the sheet of FIG. 1) defined in advance. That is, the positioning members 34, 36 limit the relative movement of the electric power storage module 14 with respect to the lower case 12 in the second direction.

Furthermore, as illustrated in FIG. 3, the side surface of the electric power storage module 14 and a surface of the positioning member 30 in contact with the electric power storage module 14 are respectively provided with a projection and a recess that are fittable together. More specifically, as illustrated in FIG. 3, a projection 15 that projects toward an inner wall of the lower case 12 is formed on the side surface of the electric power storage module 14. In addition, a recess 31 that allows the projection 15 to be fitted thereinto is formed on the surface of the positioning member 30 in contact with the electric power storage module 14. The projection 15 on the side surface of the electric power storage module 14 is fitted into the recess 31 of the positioning member to allow for the integrated movement of the electric power storage module 14 and the positioning member 30. The positioning members 32, 34, 36 are each attached to the electric power storage module 14 by a similar structure to allow for integrated movement. The electric power storage module 14 is stored in the lower case 12 with the positioning members 30, 32, 34, 36 attached to the electric power storage module 14. Such a configuration limits the relative movement of the electric power storage module 14 with respect to the lower case 12 by the positioning members 30, 32, 34, 36. A bolt 44 is inserted to each of the bolt holes 16, 18, 20, 22, 24, 26 and fastened to the nut 46 with the relative movement of the electric power storage module 14 with respect to the lower case 12 limited, thereby fixing the electric power storage module 14 to the lower case 12.

A working effect of the electric power storage apparatus 10 having the configuration as described above will be described. The projections on the side surfaces of the electric power storage module 14 are fitted into the recesses on the positioning members 30, 32, 34, 36. The electric power storage module 14 and the positioning members 30, 32, 34, 36 are therefore allowed to move integrally. The bottom surface of the lower case 12 is coated with the heat-conductive material 50 in advance. When the electric power storage module 14 and the positioning members 30, 32, 34, 36 are attached from the opening of the lower case 12, the positioning members 30, 32, 34, 36 each abut both the side surface of the electric power storage module 14 and the inner wall of the lower case 12 and limit the relative movement of the electric power storage module 14 with respect to the lower case 12. The position of the electric power storage module 14 is therefore prevented from being deviated after the electric power storage module 14 is assembled into the lower case 12. The bolts 44 are inserted to the respective bolt holes 16, 18, 20, 22, 24, 26 and fastened to the respective corresponding nuts 46 with the relative movement of the electric power storage module 14 with respect to the lower case 12 limited, thereby fixing the electric power storage module 14 to the lower case 12.

Such a configuration eliminates the necessity of jigs, such as positioning pins. A step of attaching a positioning pin to the nut 46 and a step of detaching the positioning pin from the nut 46 are therefore unnecessary. A production step is simplified.

Furthermore, for example, electric power is exchanged with an electric motor that drives a vehicle to transmit heat generated in the electric power storage module 14 to the lower case 12 through the heat-conductive material 50 and to the lower case 12 through the positioning members 30, 32, 34, 36. The heat transmitted to the lower case 12 is dissipated by the cooling device 60 and the electric power storage module 14 is hereby cooled. As described above, the positioning members 30, 32, 34, 36 help the electric power storage module 14 dissipate heat. It is therefore possible to increase the battery performance.

As described above, the electric power storage apparatus 10 according to the present embodiment makes it possible to position the electric power storage module 14 in the lower case 12 included in the housing without using any positioning pins. Furthermore, it is possible to dissipate the heat of the electric power storage module 14 to the housing through the positioning members 30, 32, 34, 36. It is therefore possible to impart a function of increasing cooling performance to each of the positioning members 30, 32, 34, 36 in addition to a positioning function. The positioning members 30, 32, 34, 36 each have a plurality of functions as described above to make it possible to prevent the production cost from increasing. It is thus possible to provide the electric power storage apparatus that prevents the positional accuracy of a part from worsening while preventing the production cost from increasing.

Furthermore, the positioning members 30, 32, 34, 36 abut the respective side surfaces of the electric power storage module 14 and the respective inner walls of the lower case 12. It is therefore possible to prevent noise from being caused by the repeated contact and separation of parts caused by vibration or the like generated while the vehicle is driven.

Positioning pins are unnecessary and the necessity of a step of attaching the positioning pins, a step of detaching the positioning pins, a step of reusing the positioning pins, and the like is thus eliminated. It is therefore possible to prevent the production cost from increasing.

Furthermore, the relative movement of the electric power storage module 14 in the housing including the lower case is prevented. Therefore, for example, even in a case where a vehicle has a collision or the like while being driven, it is possible to reduce the impact by the positioning members 30, 32, 34, 36 and reduce inertia to be generated in the electric power storage module 14.

Modification examples will be described below.

In the embodiment described above, the configuration in which the positioning members 30, 32, 34, 36 abut the lower case 12 has been described as an example. Such a configuration is not, however, limitative in particular. For example, the positioning members 30, 32, 34, 36 may also be configured to abut the upper cover in addition to the lower case 12. Furthermore, there may be provided heat-conductive materials between a lower section of each of the positioning members 30, 32, 34, 36 and the lower case 12.

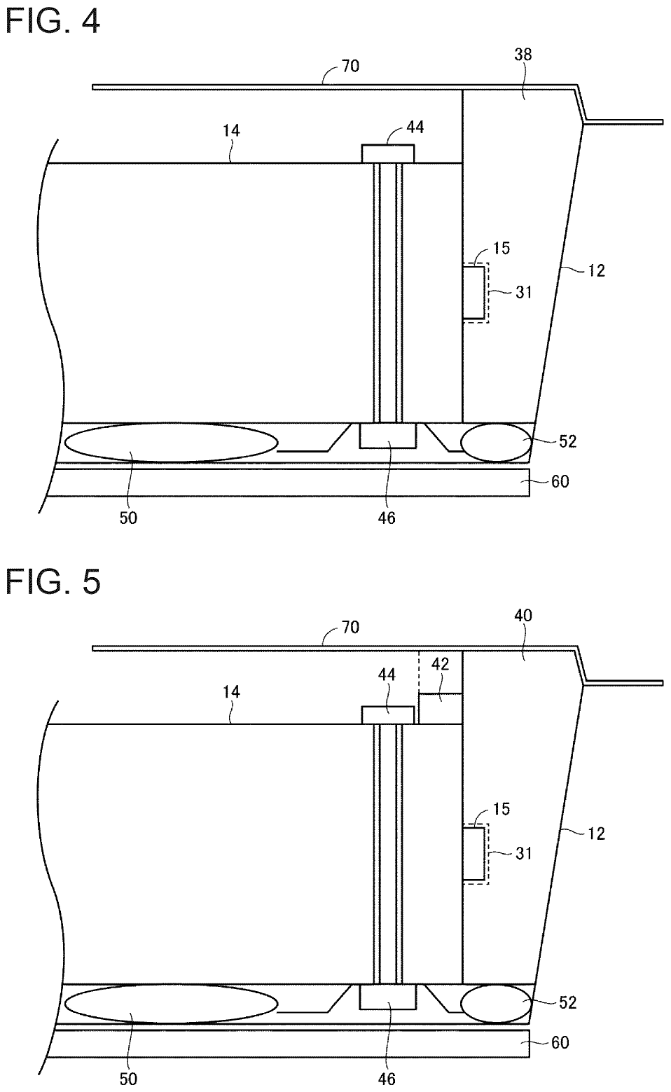

FIG. 4 is a sectional view of an example of the configuration of the electric power storage apparatus 10 according to a modification example. FIG. 4 illustrates a diagram corresponding to a section of the electric power storage apparatus 10 taken along the A-A plane in FIG. 1. The electric power storage apparatus 10 illustrated in FIG. 4 is different from the electric power storage apparatus 10 illustrated in FIG. 3 in that an upper cover 70 is illustrated, the electric power storage apparatus 10 illustrated in FIG. 4 includes a positioning member 38 instead of the positioning member 30, and there is provided a heat-conductive material 52 in addition to the heat-conductive material 50 provided on the lower case 12. The electric power storage apparatus 10 illustrated in FIG. 4 is configured in the same way as the configuration of the electric power storage apparatus 10 illustrated in FIG. 3 in other regards except for a case described below. Detailed description thereof will not be therefore repeated.

As illustrated in FIG. 4, the positioning member 38 is different from the positioning member 30 in that the positioning member 38 has a shape that projects above an upper surface of the electric power storage module 14 and reaches a position at which the upper cover 70 abuts. An upper surface of the positioning member 38 is formed such that the whole of the upper surface of the positioning member 38 conforms to the shape of the upper cover 70. Furthermore, the heat-conductive material 52 is provided between a lower section of the positioning member 38 and the lower case 12. The heat-conductive material 52 includes a silicone-based adhesive as with the heat-conductive material 50.

It is to be noted that the other positioning members corresponding to the positioning members 32, 34, 36 higher than the upper surface of the electric power storage module 14 each have a shape in which the whole of the upper surface abuts the upper cover 70 as with the positioning member 38. Detailed description thereof will not be therefore repeated. Furthermore, there is also provided a heat-conductive material similar to the heat-conductive material 52 below each of the other positioning members corresponding to the positioning members 32, 34, 36.

According to such a configuration, when the electric power storage module 14 to which the four positioning members including the positioning member 38 are attached is stored in the lower case 12 and the upper cover 70 is attached to close the upper opening of the lower case 12, the whole upper surface portions of the four positioning members abut the upper cover 70. Furthermore, the lower sections of the four positioning members each abut a heat-conductive material including the heat-conductive material 52 applied to the lower case 12. Therefore, heat generated in the electric power storage module 14 is also transmitted to the upper cover 70 and the heat-conductive materials 52 from the four positioning members. Heat is thus transmitted through more paths and it is possible to further increase the cooling performance of the electric power storage module 14.

The positioning member 38 may further be configured to limit the relative movement of the electric power storage module 14 in the up-down direction.

FIG. 5 is a sectional view of another example of the configuration of the electric power storage apparatus 10 according to a modification example. FIG. 5 illustrates a diagram corresponding to a section of the electric power storage apparatus 10 taken along the A-A plane in FIG. 1. The electric power storage apparatus 10 illustrated in FIG. 5 is different from the electric power storage apparatus 10 illustrated in FIG. 4 in that the electric power storage apparatus 10 illustrated in FIG. 5 includes a positioning member 40 instead of the positioning member 38. The electric power storage apparatus 10 illustrated in FIG. 5 is configured in the same way as the configuration of the electric power storage apparatus 10 illustrated in FIG. 4 in other regards except for a case described below. Detailed description thereof will not be therefore repeated.

As illustrated in FIG. 5, the positioning member 40 is provided with a projection 42 that abuts the upper surface of the electric power storage module 14 from above the upper surface of the electric power storage module 14 in comparison with the positioning member 38. For example, the projection 42 is provided to project in the direction (left direction of the sheet of FIG. 5) perpendicular to the surface of the positioning member 40 in contact with the electric power storage module 14. The projection 42 may be continuously formed along an end section of the upper surface of the electric power storage module 14. Alternatively, a plurality of projections 42 each having a length defined in advance may be provided spaced apart from each other at predetermined intervals. In addition, for example, as illustrated by a dashed line in FIG. 5, the projection 42 may be formed up to a position at which a lower surface of the upper cover 70 abuts. It is to be noted that the other positioning members corresponding to the positioning members 32, 34, 36 higher than the upper surface of the electric power storage module 14 each have a shape similar to the shape of the positioning member 40. Detailed description thereof will not be therefore repeated.

In such a way, it is possible to limit the relative movement of the electric power storage module 14 with respect to the housing (the upper cover 70 and the lower case 12) in the up-down direction by the four positioning members in addition to the horizontal direction.

Furthermore, in the embodiment described above, the case in which the electric power storage module 14 has a rectangular shape has been described as an example, but the electric power storage module 14 is not limited to a rectangular shape in particular. The electric power storage module 14 is not limited in particular to a three-dimensional object the facing end faces of which have a parallel relationship in particular. In addition, the end faces that form the electric power storage module 14 are not limited to flat surfaces in particular, and may be curved surfaces.

Furthermore, in the embodiment described above, the configuration in which the electric power storage module 14 is provided with the projection 15 and the positioning member 30 is provided with the recess 31 has been described as an example, but the electric power storage module 14 may be provided with a recess and the positioning member 30 may be provided with a projection that is fittable into the recess.

Furthermore, in the embodiment described above, the configuration in which the positioning members are continuously formed along the respective side surfaces of the electric power storage module 14 has been described as an example, but the positioning members may be provided at a plurality of positions (e.g., two positions) along a side surface to be separated by a distance defined in advance.

Furthermore, in the embodiment described above, the case where the positioning members are each formed by using, for example, resin, rubber, or the like has been described as an example. However, the positioning members may be each formed by attaching, for example, an insulating member to metal or the like, such as aluminum.

Furthermore, in the embodiment described above, the configuration in which the positioning members 30, 32, 34, 36 abut both the lower case 12 and the electric power storage module 14 has been described as an example. However, a heat-conductive material may be applied between at least any of the positioning members 30, 32, 34, 36 and the lower case 12. Alternatively, a heat-conductive material may be applied between at least any of the positioning members 30, 32, 34, 36 and the electric power storage module 14.

Furthermore, in the embodiment described above, the configuration in which the side surface of the electric power storage module 14 and the surface of the positioning member 30 in contact with the electric power storage module 14 are respectively provided with a projection and a recess that are fittable together has been described as an example. However, the side surface of the electric power storage module 14 may be provided with a plurality of projections and the surface of the positioning member 30 in contact with the electric power storage module 14 may be provided with a plurality of recesses that allows the projections to be fitted thereinto. Alternatively, the side surface of the electric power storage module 14 may be provided with a projection and a recess and the surface of the positioning member 30 in contact with the electric power storage module 14 may be provided with a recess that allows the projection of the electric power storage module 14 to be fitted thereinto and a projection that is fittable into the recess of the electric power storage module 14.

It is to be noted that all or some of the modification examples described above may be carried out in combination as appropriate.

The embodiment disclosed herein should be understood as an example in all respects, and should not be understood as being limitative. The scope of the present disclosure is demonstrated by the claims instead of the description. The scope of the present disclosure is intended to include all modifications within the meaning and scope equivalent to the claims.

What is claimed is:

1. An electric power storage apparatus comprising:
an electric power storage module;
a housing configured to house the electric power storage module; and
a positioning member configured to abut both a side surface of the electric power storage module and an inner wall of the housing and limit relative movement of the electric power storage module in the housing, the positioning member being provided in a gap in which the side surface and the inner wall face each other, wherein
the positioning member includes a material having thermal conductivity, the material being deformable according to the gap.

2. The electric power storage apparatus according to claim 1, wherein the positioning member includes a first member and a second member that are provided to sandwich the electric power storage module in a direction defined in advance and limit the relative movement in the direction defined in advance.

3. The electric power storage apparatus according to claim 1, wherein the side surface of the electric power storage module and a surface of the positioning member in contact with the electric power storage module are respectively provided with a projection and a recess that are fittable together.

4. The electric power storage apparatus according to claim 1, wherein
the housing includes an upper cover and a lower case, and
the positioning member is configured such that an upper end of the positioning member abuts the upper cover.

5. The electric power storage apparatus according to claim 4, wherein the positioning member further includes a projection that abuts an upper surface of the electric power storage module.
